(19) United States
(12) Patent Application Publication
(10) Pub. No.: US 2021/0097527 A1
(43) Pub. Date: Apr. 1, 2021

(54) METHODS AND SYSTEMS FOR ACCOUNT CREATION

(71) Applicant: Shopify Inc., Ottawa (CA)

(72) Inventors: Emile Filteau-Tessier, Montréal (CA); Amir Saboury, Montréal (CA); Mathias Boutin, Montréal (CA)

(21) Appl. No.: 16/589,311

(22) Filed: Oct. 1, 2019

(51) Int. Cl. G06Q 20/36

(52) U.S. Cl. CPC G06Q 20/367; G06Q 20/3674

(57) ABSTRACT

A method for a payment resource associated with a first domain may include receiving, from a commerce management engine for a storefront associated with a second domain, customer account information for a customer of the storefront, wherein the customer account information includes customer payment information. A request to create a customer account for the customer for future use of the customer payment information may also be received. The customer account may be created at the payment resource for storage of the customer account information. The payment resource may be configured to store the customer account information and provide the customer account information to a transaction device for completing a transaction with a storefront associated with a third domain.

### FIELD

The present disclosure relates generally to an e-commerce platform for managing online and physical stores, and more specifically to systems and methods relating to creating a payment resource account for a customer for storing customer payment information, wherein the stored customer payment information may be used in multiple stores.

### BACKGROUND

A merchant may use a storefront associated with an e-commerce platform to sell products to customers. A customer shopping at the storefront typically adds items to a cart, then may proceed to a checkout page where the customer enters customer data such as a name, a shipping address, and customer payment information, such as by entering a credit card number, expiration date, card security code, and billing address. A customer may also use customer information stored in their device (e.g., using a cookie) for checkout. For example, when a customer purchases a product at a storefront, a customer may be provided with an option to save the customer's information, including payment information, on their device. However, the stored customer information for that storefront may not be easily used at other storefronts. Customers may also use a third party service that acts as a payment resource (such as Google Pay®, Apple Wallet®, or PayPal®). These third party services typically store customer information and customer payment information for use at other stores, but using such a third party service requires that a corresponding customer account be created by the customer directly with the third party service and requires that the customer be logged in to the payment resource customer account, which typically means entering a password or code. There is therefore a need for a more streamlined approach for creating a payment resource account for a customer so that it can be used across different storefronts.

### SUMMARY

In embodiments, a method for a payment resource associated with a first domain may include receiving, from a commerce management engine for a storefront associated with a second domain, customer account information for a customer of the storefront. The customer account information may include customer payment information. The payment resource may receive a request to create a customer account for the customer for future use of the customer payment information. The payment resource may create the customer account at the payment resource for storage of the customer account information. The payment resource may store the customer account information, and the payment resource may be configured to provide the customer account information to a transaction device for completing transactions with at least one storefront associated with a third domain.

In embodiments, the request to create a customer account may be received at the payment resource in response to a customer agreement to future use of the customer payment information received at the commerce management engine from the transaction device. The customer agreement to future use of the customer payment information may be received at the commerce management engine together with a transaction authorization from the transaction device for a transaction with the storefront associated with the second domain. The payment resource may store an associated authorization token, wherein a presentation of the authorization token from the transaction device to the payment resource is necessary but not sufficient to access the customer payment information for carrying out a transaction with a storefront associated with the second or with the third domain. The payment resource may store an associated authorization token, wherein a presentation of the authorization token from the transaction device to the payment resource may allow for access to the customer payment information for carrying out a transaction with a storefront associated with the second or with the third domain. The customer account data may comprise a customer ID, a customer name, a shipping address, a payment source, and a billing address. One or more of the customer ID, the customer name, the shipping address, the payment source, the billing address, and the request to create a customer account for the customer may be received via a checkout page of the storefront associated with the second domain. The payment resource may store an associated authorization token, wherein a presentation of the authorization token to the payment resource may allow for access to the customer payment information for carrying out a transaction with a storefront associated with the second or with the third domain, and the authorization token may be sent to the transaction device.

In embodiments, the payment resource may store an associated authorization token, wherein a presentation of the authorization token from the transaction device to the payment resource may allow for access to the customer payment information for carrying out a transaction with a storefront associated with the second or with the third domain and may send the authorization token to the transaction device via the commerce management engine. The payment resource may receive, from the transaction device, a transaction authorization for a transaction with a storefront associated with the second or with the third domain, a customer ID, and the authorization token; and may send, to the commerce management engine, an indication that the transaction with the storefront associated with the second or with the third domain is complete. The payment resource may send, to the commerce management engine, a shipping address associated with the transaction. The payment resource may receive a security code from the transaction device prior to sending the customer payment information for carrying out the transaction with the storefront associated with the second or with the third domain. The payment resource may store an associated authorization token, wherein a presentation of the authorization token from the transaction device to the payment resource allows access to the customer payment information. The payment resource may send the authorization token to the commerce management engine and to the transaction device and may receive a checkout request and the authorization token from the transaction device. The payment resource may create an account session, may receive updated customer payment information from the transaction device, and may store the updated customer payment information. The customer account information may include a customer identifier that is at least one of a customer name, an email address, and a telephone number. The customer payment information may include a payment source and a billing address. The authorization token may take the form of at least one of a JSON token and a payment resource cookie.

In embodiments, a system may include a payment resource, wherein the payment resource may be associated with a first domain and in communication with a commerce management engine for a storefront associated with a second domain. The payment resource may be configured to: receive, from the commerce management engine for a storefront associated with a second domain, customer account information for a customer of the storefront, wherein the customer account information includes customer payment information, and a request to create a customer account for the customer for future use of the customer account information; create the customer account at the payment resource for storage of the customer account information; and store the customer account information, wherein the payment resource is configured to provide the customer account information to a transaction device for completing transactions with at least one storefront associated with a third domain.

In embodiments, the payment resource may store an authorization token, and wherein a presentation of the authorization token to the payment resource may allow for access to the customer payment information. The authorization token may be made available to the commerce management facility and to the transaction device. One or more of a transaction authorization, a customer name, a customer ID, and a shipping address may be received via the a checkout page of a storefront from the transaction device.

In embodiments, a method for a payment resource associated with a first domain may include receiving, from a commerce management engine for a storefront associated with a second domain, customer account information for a customer of the storefront. The customer account information may include customer payment information. The payment resource may receive a request to create a customer account for the customer for future use of the customer account information. The request to create a customer account may be received at the payment resource in response to a customer agreement to future use of the customer payment information received at the commerce management engine from a transaction device of the customer together with a transaction authorization from the transaction device for a transaction with the storefront associated with the second domain. The payment resource may create the customer account at the payment resource for storage of the customer account information and may store the customer account information and an associated authorization token. The payment resource may send the authorization token to the transaction device and may receive the authorization token from the transaction device and may allow access to the customer payment information for carrying out a transaction via the transaction device with a storefront associated with a third domain.

### BRIEF DESCRIPTION OF THE FIGURES

FIG. 1 depicts an embodiment of an e-commerce platform.

FIG. 2 depicts an embodiment for a home page of an administrator.

FIG. 3 depicts an embodiment of a block diagram of an e-commerce platform including a payment resource.

FIG. 4 depicts an exemplary process for creating a payment resource account to store customer account information after a customer agreement for future use of the customer account information.

FIG. 5 depicts an exemplary process for creating a payment resource account to store customer account information after a completed transaction at a first storefront and after a customer agreement for future use of the customer account information.

FIG. 6 depicts an exemplary process for using customer account information stored by the payment resource after a completed transaction at a first storefront to be used in a transaction at a second storefront in a different domain than the first storefront.

FIG. 7 depicts an exemplary user interface for allowing a customer to indicate agreement for storing customer account information with a payment resource and using the stored customer account information in conjunction with future transactions.

FIG. 8 depicts an exemplary user interface for allowing for allowing a customer to login to or create a customer account for one or more payment resources.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

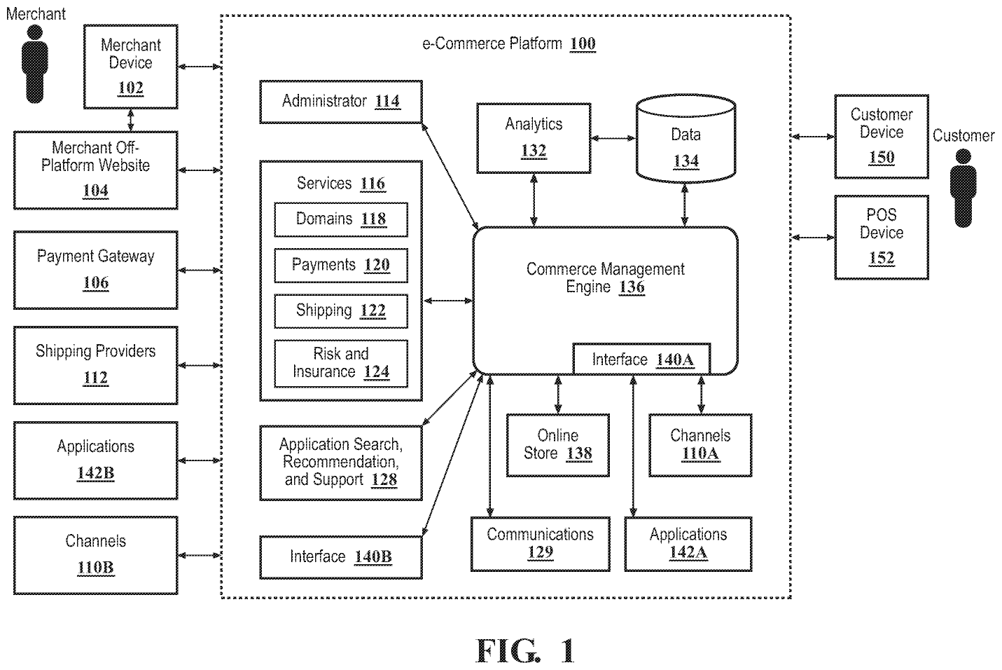

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store). Throughout this disclosure the terms online store 138 and storefront may be used in connection with an online e-commerce presence, an offline commerce presence (such as a physical store), an online channel, an offline channel, a channel 110A internal to the platform 100, a channel 110B external to the platform 100, or the like, or any combination of the foregoing.

In embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

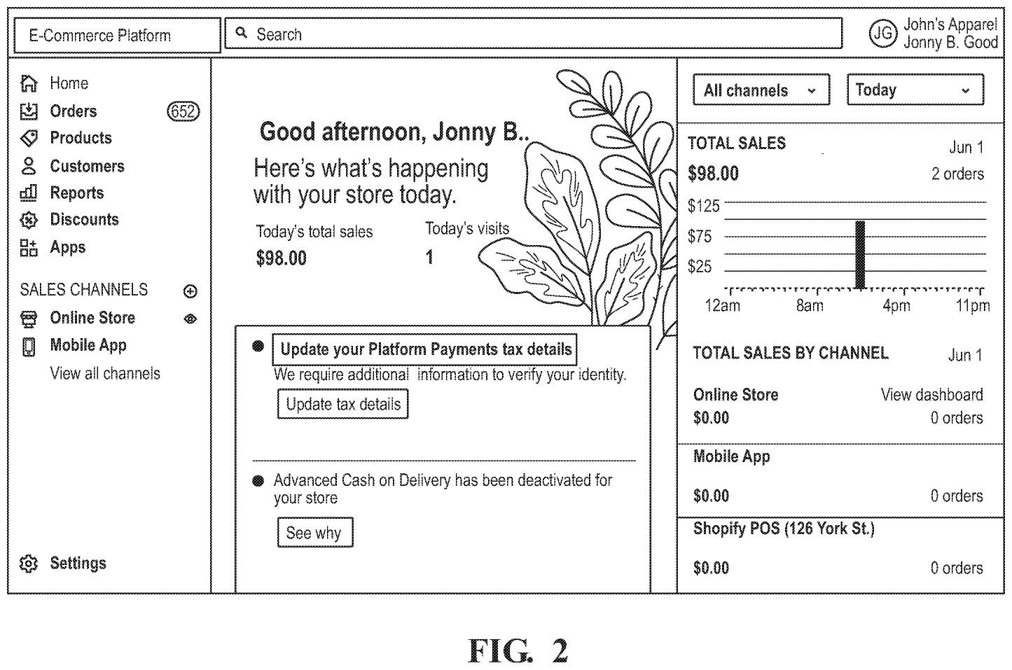

FIG. 2 depicts a non-limiting embodiment for a home page of an administrator 114, which may show information about daily tasks, a store's recent activity, and the next steps a merchant can take to build their business. In embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In embodiments, an application 142A may be provided by the same party providing the platform 100 or by a different party. In embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In embodiments, rather than violating the isolation principle, it may be preferred to move these components out of the commerce management engine 136 and into their own infrastructure within the e-commerce platform 100.

In embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In embodiments, core products, core extension points, applications, and the administrator 114 may be developed to work together. For instance, application extension points may be built inside the administrator 114 so that core features may be extended by way of applications, which may deliver functionality to a merchant through the extension.

In embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In embodiments, partners, application developers, internal applications facilities, and the like, may be provided with a software development kit (SDK), such as through creating a frame within the administrator 114 that sandboxes an application interface. In embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In embodiments, update events may be queued and processed asynchronously from a state change that triggered them, which may produce an update event notification that is not distributed in real-time.

In embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In embodiments, the payment gateway 106 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In embodiments, the e-commerce platform 100 may enable merchants to keep track of changes to the contract of sales over time, such as implemented through a sales model component (e.g., an append-only date-based ledger that records sale-related events that happened to an item).

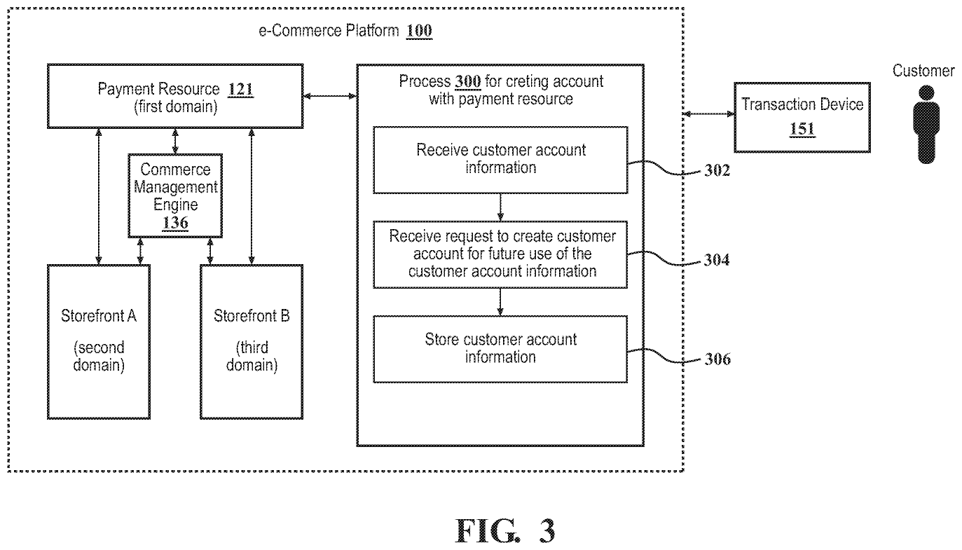

A payment resource 121, as shown in FIG. 3 and described herein, may (securely) store customer account information, including customer payment information, to facilitate transactions at storefronts, such as those storefronts associated with a commerce management engine 136. A customer account with the payment resource 121 may be created in a seamless way and may be accessible in a simple and straightforward manner to use the customer payment information for transactions at different storefronts (including those associated with or outside the e-commerce platform 100). The payment resource 121 and methods associated with its use are advantageous for both customers and merchants. For example, a payment resource account for a customer may be created which leverages some or all of previously entered customer information and an implicit or explicit opt-in agreement for such an account, with the ability to use the customer account information, including customer payment information, in the future and at multiple storefronts, such as ones in different domains from each other and the payment resource 121.

Such a payment resource account may be convenient for a customer because the customer may easily complete other transactions without having credit card or bank information on hand and the customer need not spend time or effort filling in such information because the payment resource may pre-populate customer account information, such as payment details, a user identifier or ID, shipping addresses, and/or billing addresses. A payment resource 121 that is not tied to a particular storefront on one domain but may be used at another storefront in a different domain provides flexibility and convenience for the customer and advantages for merchants in that it may increase sales and lessen the occurrence of abandoned shopping carts. Additionally, the payment resource 121 may lessen compliance responsibilities for storefronts, because certain customer account information, such as PAN (Primary Account Numbers) or bank information, need not reside on the servers associated with the storefronts, instead residing at one or more servers associated with the payment resource 121.

FIG. 3 depicts an exemplary block diagram for a payment resource 121 that is in communication with the commerce management engine 136 and one or more storefronts, represented as storefront A and storefront B. The payment resource 121 may be, or may be associated with, payment gateway 106, and/or payment facility 120 of FIG. 1 and as described herein. In embodiments, the payment resource 121 may comprise a system such as SHOPIFY PAY™ and/or PAYPAL™. As shown, the payment resource 121 is a component of the e-commerce platform 100, although, in embodiments, it may also be a separate component from the e-commerce platform 100. Similarly, each storefront (storefront A and storefront B) may be a component of the e-commerce platform 100 or external to it.

In embodiments, the payment resource 121 may be in a first domain, storefront A in a second domain, and storefront B in a third domain. The second and third domains may be second level domains (SLDs) registered on a Domain Name System (DNS) on the Internet and defined by their numerical IP address(es). A domain name, which may be an SLD or a higher level domain such as a third-level or fourth-level domain, is used to identify the IP address(es) and typically is a human-readable DNS registration to identify particular web pages. Each domain may have or be associated with a particular domain controller that governs all basic domain functions and manages network security. Thus, each separate storefront may have separate user accounts and a separate system for authentication and access to those accounts. The payment resource 121 and methods associated with its use may manage authentication and access to customer account information for use in storefronts in different domains.

In embodiments, a transaction device 151 is configured for communication (via a network) with the e-commerce platform and the components shown in FIG. 3. The transaction device 151 may be any device used in connection with a transaction by a customer, including for example, a customer device 150 (e.g., computer, laptop computer, mobile computing device, and the like), a POS device 152 (e.g., retail device, a kiosk, an automated checkout system, and the like), or any other transaction device known in the art. In embodiments, a transaction may be considered to be any interaction with an online store or storefront; for example, a transaction may be a product view or selection for a cart, a purchase, a refund, a changing of account information, or the like.

The payment resource 121 may be configured to perform the steps of process 300 shown in FIG. 3, and the creation of a customer account for the payment resource 121 may occur simply and seamlessly without the customer having to take the time and effort to set up a separate account with the payment resource 121 or directly interact with the payment resource 121. In embodiments, a delegated account may be created at the payment resource 121 via opt-in from a third party site, e.g., a storefront. In embodiments, a customer account may not have a corresponding username and password for access, relying instead on an authentication token, although in some embodiments, a customer account with the payment resource may have an associated username, such as customer ID, and an associated password for access to and/or as an additional security measure for access to the customer account information. In embodiments, the username and/or password may be determined by a customer and in some embodiments may be automatically generated. As explained further herein, the payment resource 121 may receive various types of customer account information, which may include various types of customer payment information, at a step 302. The payment resource 121, at a step 304, may receive a request to create a customer account, such as an agreement for opting in for future use of the stored customer account information, which may come from the customer via the transaction device 151. A customer may agree to store some or all of the different types of received customer account information. For example, a customer may agree to store one or more shipping and/or billing addresses but not all necessary parts of a payment source itself, such that not all the customer payment information is stored by the payment resource 121. This may provide additional safeguards to unauthorized use of the customer payment information as the stored customer payment information is incomplete. At a step 306, the payment resource 121 may store the appropriate customer account information in accordance with the account creation request.

In embodiments, customer account information may include various types of information about a customer, such as customer name(s), customer identifier(s) (ID(s)), e-mail address(es), telephone number(s), shipping address(es), user name(s), alias(es), image(s), avatar(s), date of birth, sex, security question(s) and/or corresponding answer(s), and the like.

In embodiments, the customer account information may include customer payment information, which may include payment source information, such as payment type (credit card, debit card, prepaid card, loyalty card, bank account information, information on another payment resource), account information for that type (such as account number, credit card number, expiration, card verification value, name of cardholder, bank routing number, and the like), and a billing address corresponding to the account, cardholder or account owner. In embodiments, the customer payment information may have an associated password.

The customer account information may be stored in a data record in memory of the payment resource 121, or may be stored as a table in memory of the payment resource 121.

In embodiments, the e-commerce platform may include a tokenization system for securely storing some or all of the customer account information, such as sensitive account information which is transmitted to, generated by, and/or accessed at various points by the payment resource 121, the storefronts, and/or by the commerce management engine 136, and communicated to and/or from various entities in communication with the e-commerce platform 100, including customers, transaction devices 151, merchants and merchant devices 102.

The payment resource 121 may include or interact with such a tokenization system, wherein sensitive data, such as payment card (e.g., a credit or debit card) information or bank account numbers, is replaced with a token (in general, a unique, undecipherable reference such as a random number, with no intrinsic value of its own), and the sensitive data may be stored in a secure storage or data vault.

Sensitive information, as used herein, may include any and all data that is to be protected against unwarranted disclosure, and may encompass many types of data such as personally identifiable information (PII), personal data, personal information, names, mailing addresses, phone numbers, email addresses, user names, marital status, gender, relationships with others, financial data, payment information and the like. Such data may reside at different places in the e-commerce platform 100 and be associated with various data facilities or storage services such as HDFS (Hadoop Distributed File System), Amazon S3, log files, RDBSs (relational database systems), and the like.

In embodiments, a tokenization system includes a tokenization engine and a data vault for collection, access, and management of the sensitive information included in the customer account information. The tokenization engine may provide a corresponding token for data to be protected (e.g., PII) in combination with other information, such as a customer ID. A token may use a randomly generated number to generate a unique hexadecimal string that is associated with the protected data. The tokenization engine may control storage of the tokenized data in the data vault, and control release of the tokenized data from the data vault upon request by an entity in possession of the corresponding authorization token by authenticating the token and authorizing the access.

With respect to customer payment information that includes credit cards as payment sources, the payment resource 121 may conform to the payment card industry (PCI) data security standards, which is a set of security standards designed to ensure that organizations that accept, process, store, or transmit credit card information maintain a secure environment. The payment resource 121 may conform to a level of compliance based on activity of the storefronts, as the standards may provide different levels of compliance based on the number of card transactions processed per year.

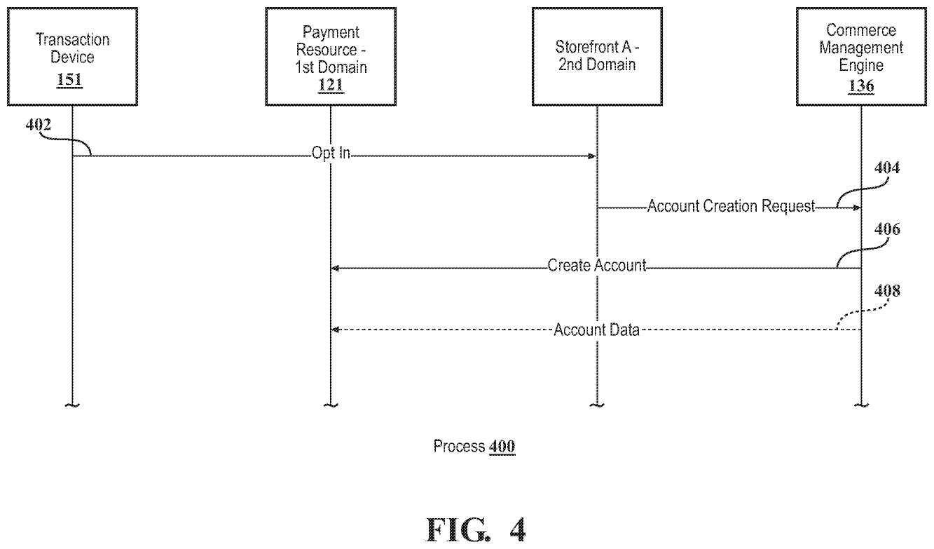

With reference to FIG. 4, an exemplary process 400 for creating a payment resource account to store customer account information is depicted. As shown, a customer in communication with storefront A may provide to storefront A, via transaction device 151 (such as via inputs to a web browser stored in memory on and running on a processor on the transaction device 151), an agreement for opting-in to future use of customer account, which acts as an agreement for having a payment resource account created. Storefront A may then communicate the agreement for creating an account to the commerce management engine 136, such as over a network. The commerce management engine 136, in communication with the payment resource 121, may send a create account request to the payment resource 121, along with corresponding customer account information. In response to receiving the create account request and the customer account information, the payment resource 121 may store the corresponding customer account information as a data record in memory and/or the customer account information may be stored as a table in memory.

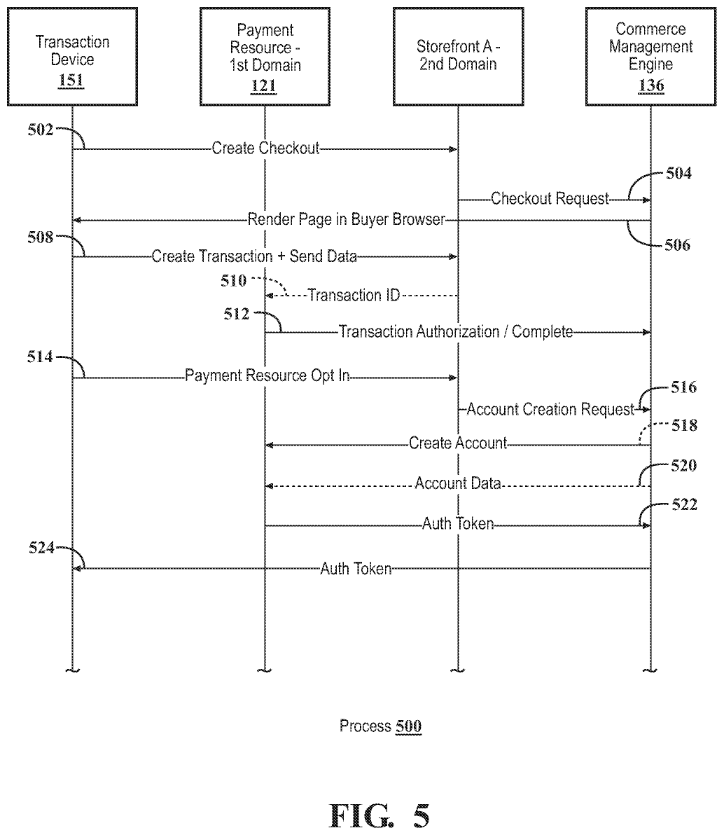

FIG. 5 depicts an exemplary process 500 for creating a payment resource account to store customer account information, such as in conjunction with a transaction session between the transaction device 151 and storefront A, wherein the transaction session relates to a transaction that is initiated, in process, or completed during the transaction session, and when an agreement for opting in to future use of customer payment information has been provided. In particular, at a step 502, a customer, via transaction device 151 (such as via inputs to a web browser stored in memory on and running on a processor on the transaction device 151), may create a transaction session with storefront A, by browsing products at storefront A and creating a cart for checkout with storefront A. At a step 504, a checkout request may be sent from storefront A to the commerce management engine 136. At a step 506, the commerce management engine 136 may facilitate a checkout page being rendered in a browser of the transaction device 151.

At a step 508, a customer may proceed to enter information relevant to the transaction via the transaction device 151. Relevant information for a product purchase may include, for example, a customer name, a customer email address, a shipping address, and customer payment information. Other customer account information may also be provided, as described elsewhere herein. The customer account information is sent to and received by storefront A and/or a commerce management engine 136 in association with storefront A.

Storefront A interacts and/or communicates with the payment resource 121, and at a step 510, a transaction ID may be sent to the payment resource 121, along with the relevant customer account information for the transaction. At a step 512, the payment resource 121 may facilitate completion of the transaction and notify the commerce management engine 136 by providing an indication that the transaction is authorized and/or completed. At a step 514, which may occur any time during a transaction session between the transaction device 151 and the storefront A, an indication may be provided, via the transaction device 151 to storefront A, that a customer desires to opt-in to (e.g., agrees to) storing the customer payment information with the payment resource 121. At a step 516, storefront A sends an account creation request to the commerce management engine 136. At a step 518, the commerce management engine 136 sends a request to create a customer account to the payment resource 121, which stems from the customer indication agreeing to store the customer payment information for future use. As described, these steps represent the commerce management engine 136 passing on an account creation request originating from the transaction device 121 incident to a transaction session, wherein the request passes through a storefront. In embodiments, an opt-in may occur, wherein a transaction device 121 interacts directly with the commerce management engine 136 or where the commerce management engine 136 interacts with the payment resource 121. In embodiments, a customer agreement for opting-in to the payment resource may be implicit rather than explicit. For example, a customer may have a transaction session for storefront A with items in a cart and a checkout request pending. In such a case, the commerce management engine 136 may receive a password which triggers a create account request to the payment resource. An implicit opt-in may include some but not all of the entered customer account information.

The commerce management engine 136 may also send customer account information, such as a customer ID or the like, to the payment resource 121, and the payment resource 121 creates a customer account and stores the customer payment information together with a customer ID. At a step 522, an authentication token tied to the customer account is sent to the commerce management engine 136. At a step 524, the commerce management engine 136 sends the authorization token to the transaction device 151, wherein it may be saved, for example, on the browser of the transaction device 151. Once a customer account is created for a customer with the payment resource 121, the payment resource 121 is usable to provide the customer account information for completing transactions with other storefronts, such as those in the same or a different domain. Additionally, in embodiments, use of the payment resource account to access stored customer payment information may or may not require the use of a separate password, code or device for security.

An authentication token may take various forms, such as authentication tokens or computer cookies. For example, an authentication token may take the form of a JSON (JavaScript Object Notation) web token, which relies on an Internet standard for creating access tokens that may perform one or more functions, such as authentication of an entity in possession of the token. In embodiments, the token may be signed by one party's private key, such as by the payment resource 121, and the recipient, such as a transaction device 151 of a customer, may be in possession of a corresponding public key, such that both parties (the payment resource 121 and the customer) are able to verify that the token is legitimate. Such tokens are advantageous in that they are designed to be compact, URL-safe, and usable especially in a web-browser context for single sign on authentication.

The storefronts A and B and the payment resource 121 may use also use computer cookies (also known as HTTP cookies, web cookies, Internet cookies, browser cookies, or simply cookies), which are pieces of information sent from one entity and stored on a customer's device (e.g., in relation to a browser), such as sent from storefront A while a customer is browsing at the storefront A. Cookies may be used as a mechanism for websites to remember information regarding a user, such as a customer's browsing activity on the website, including which pages are visited, which links are clicked, or which items are added to a shopping cart of a storefront. Cookies may also be used to remember information that a customer has previously entered into form fields on a website, such as names, addresses, email addresses, and the like. Cookies may also provide an authentication function, for example to ensure that a user is logged in to an account on the website before providing a user with sensitive information that the user previously entered into form fields such as names, addresses, usernames, or passwords. A cookie sent from the payment resource 121 to the transaction device 151 may provide an authentication function. A cookie may have some or all of its content encrypted. However, in embodiments, the content of a cookie may only be valid on a domain on which it is created.

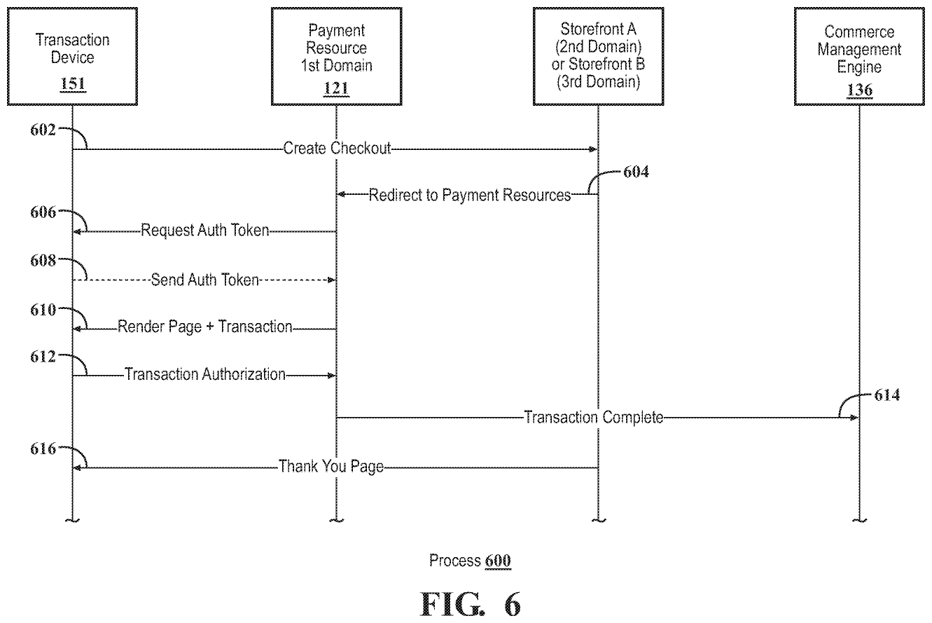

FIG. 6 depicts an exemplary process 600 for using customer account information stored by the payment resource 121 for a transaction at a storefront. In embodiments, process 600 occurs after process 500, such that the stored customer account information was in conjunction with a transaction at storefront A. However, the process 600 illustrates that the stored customer account information may be used in a transaction at storefront B, which is a different domain than that of storefront A.

At a step 602, the customer, via transaction device 151, may create a transaction session with storefront B (or A), by creating a checkout with storefront B, wherein a checkout request may be redirected from storefront B to the payment resource at a step 604.

At a step 606, the payment resource 121 may send a request to the transaction device 151 for the authentication token, which may be stored in (or associated with) the browser of the transaction device 151 (or elsewhere local to the device 151). At a step 608, the authentication token is sent from the transaction device 151 to the payment resource 121. The token may be sent automatically in response to the authentication token request, or there may be a confirmatory loop prior to it being sent, with a query to the customer asking whether the customer wants to share the authentication token. This optional query may protect from a man in the middle attack.

Once the payment resource 121 receives the authentication token (or other means of authentication), the payment resource 121 may authenticate and/or “login” the customer via the transaction device 151 for allowing access to the customer account information. At a step 610, the payment resource 121 may enable a rendering of a checkout page with transaction information on the browser of the transaction device 151, wherein the transaction information may include customer details such as name, shipping address, and billing address, and other information pre-populated for the convenience of the customer.

The transaction information may also include the customer payment information. In embodiments, some of the payment information may be redacted, such as by displaying a type or name of a credit card with a symbol such as “x” or “*” in place of the digits other than the last four digits. The customer payment information may be incomplete, with some information required to be entered, such as a credit card security code and/or expiration date. This may provide additional security for the customer regarding use of stored customer payment information.

If the transaction details and customer account information are correct and match, the customer, via the transaction device 151, may provide a transaction authorization to the payment resource 121 at a step 612, and the payment resource 121 may facilitate completion of the transaction, such as a transfer of funds to the storefront involved in the transaction from the stored payment source, and may provide an indication of a completed transaction to the commerce management engine 136 at a step 614. This completed transaction message may include details of the transaction as well, including a customer ID, a customer name, a customer shipping address, a customer billing address, and any other relevant information. In this manner, information about transactions, including purchases from the storefronts, may be funneled to a single entity, i.e., the commerce management engine 136 and aggregated. In this manner, there can be a record of all transactions related to a customer ID, such as across the different storefronts. This aggregated information could also be generated and reside at the payment resource 121, wherein a customer ID or the like may act as an aggregating factor across the storefronts. The information may be aggregated even in the absence of a transaction (for example, aggregating information regarding products a customer has viewed).

Upon a completed transaction, a completed transaction and thank you page may be provided to the transaction device from the storefront (A or B) at a step 616.

In the case that an authentication token is not available, such as may be the case when a customer clears the browser or uses a different transaction device, the payment resource 121 may be configured to send a security code (e.g., via a text message or a mobile application) to the transaction device 121 or a mobile device associated with the customer, such that the security code may be used to authenticate the customer instead of the token. In embodiments, a password, answers to security questions, or other security measures may also be enforced for the access to the customer account information.

In embodiments, an authentication token may be necessary but not sufficient to access the customer payment information held by the payment resource, as in some cases, it may be desirable to require two-factor authentication. In that case, a password, a code sent via a text message or a mobile application, or the like, may also be used to provide the second authentication factor.

A presentation of the authorization token from the transaction device 151 to the payment resource 121 may allow an account session to be created, without having to send a checkout request, and allow a customer to update the customer payment information, such as to change a payment source, change account numbers, change a billing address, and the like. The updated customer payment information may then be stored in the payment resource 121.

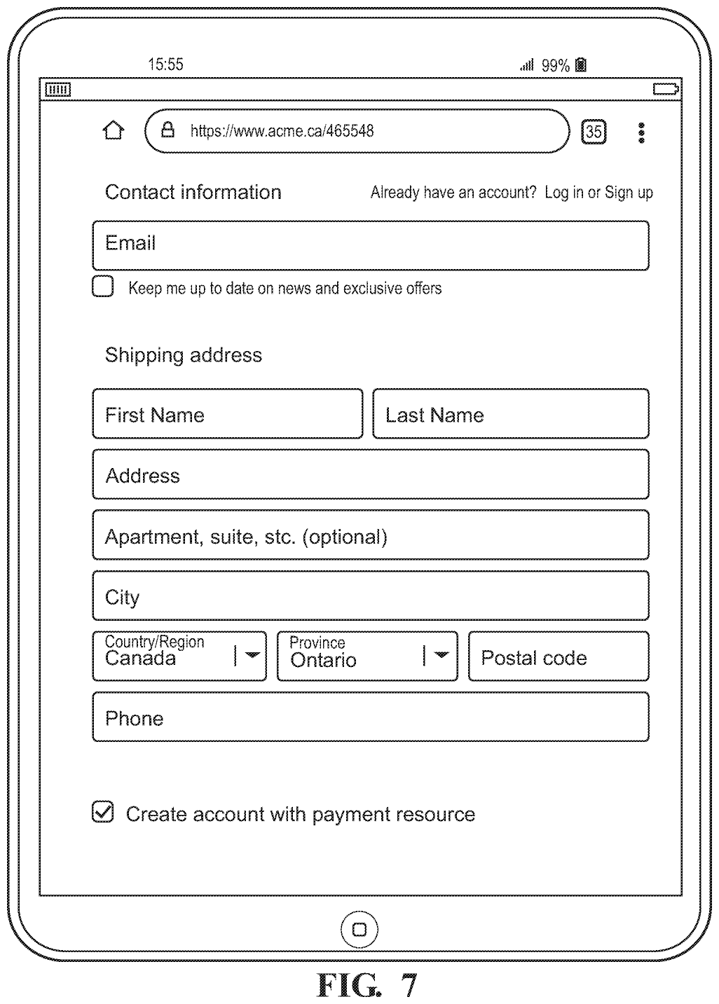

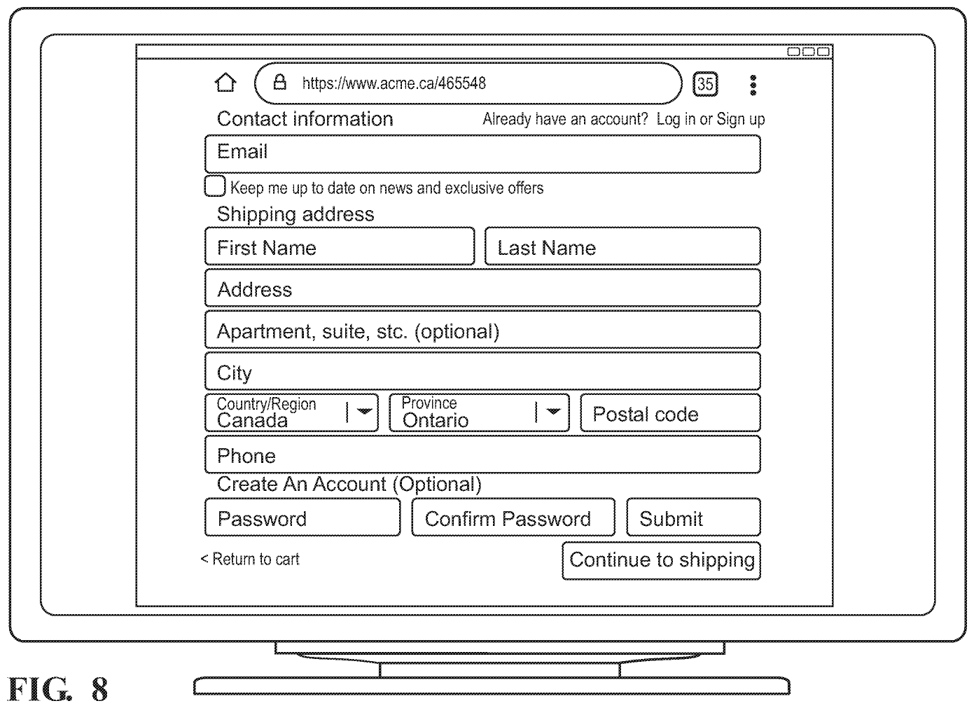

Referring to FIGS. 7 and 8, exemplary user interfaces 700 and 800 are illustrated for mobile transaction devices and customer computing devices, wherein the user interfaces enable a customer to complete a transaction and enable creation of a customer account on the payment resource. As illustrated in FIG. 7, a user interface 700 for a mobile device may allow a customer to simply check a box to indicate an agreement for opting-in to future use of the payment resource. In embodiments, the box may be checked as a default or according to a setting configured by the customer, or a system default may be to create an account for a customer on the payment resource unless a customer opts-out of saving the information, and a box may be provided for opting out. As illustrated in FIG. 8, a user interface 800 for a computing device may allow a customer to create a payment resource account by entering a password (as an alternative or in addition to an opt-in), wherein a customer ID associated with the account may be a customer's email address or mobile device telephone number could be used in conjunction with the password to access stored customer account information. In embodiments, a customer may be able to opt-in to more than one payment resource with a single opt-in agreement, in which case the methods and systems described herein may be performed or used in connection with more than one payment resource in series and/or parallel.

Additionally, pop-ups on a user interface may alert a customer to transaction fields that need to be completed or corrected.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4^{th} Generation (4G) networks (e.g. Long Term Evolution (LTE)) or 5^{th} Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A method for a payment resource associated with a first domain, the method comprising:
receiving, from a commerce management engine for a storefront associated with a second domain, customer account information for a customer of the storefront, wherein the customer account information includes customer payment information, and a request to create a customer account for the customer for future use of the customer payment information;
creating the customer account at the payment resource for storage of the customer account information; and
storing the customer account information, wherein the payment resource is configured to provide the customer account information to a transaction device for completing transactions with at least one storefront associated with a third domain.

2. The method of claim 1, wherein the request to create a customer account is received at the payment resource in response to a customer agreement to future use of the customer payment information received at the commerce management engine from the transaction device.

3. The method of claim 2, wherein the customer agreement to future use of the customer payment information is received at the commerce management engine together with a transaction authorization from the transaction device for a transaction with the storefront associated with the second domain.

4. The method of claim 1, further comprising storing an associated authorization token, wherein a presentation of the authorization token from the transaction device to the payment resource is necessary but not sufficient to access the customer payment information for carrying out a transaction with a storefront associated with the second or with the third domain.

5. The method of claim 1, further comprising storing an associated authorization token, wherein a presentation of the authorization token from the transaction device to the payment resource allows for access to the customer payment information for carrying out a transaction with a storefront associated with the second or with the third domain.

6. The method of claim 1, wherein the customer account data comprises a customer ID, a customer name, a shipping address, a payment source, and a billing address.

7. The method of claim 6, wherein one or more of the customer ID, the customer name, the shipping address, the payment source, the billing address, and the request to create a customer account for the customer is received via a checkout page of the storefront associated with the second domain.

8. The method of claim 1, further comprising storing an associated authorization token, wherein a presentation of the authorization token to the payment resource allows for access to the customer payment information for carrying out a transaction with a storefront associated with the second or with the third domain; and
sending the authorization token to the transaction device.

9. The method of claim 1, further comprising storing an associated authorization token, wherein a presentation of the authorization token from the transaction device to the payment resource allows for access to the customer payment information for carrying out a transaction with a storefront associated with the second or with the third domain;
sending the authorization token to the transaction device via the commerce management engine.

10. The method of claim 9, further comprising:
receiving from the transaction device, a transaction authorization for a transaction with a storefront associated with the second or with the third domain, a customer ID, and the authorization token; and
sending, to the commerce management engine, an indication that the transaction with the storefront associated with the second or with the third domain is complete.

11. The method of claim 10, further comprising, sending, to the commerce management engine, a shipping address associated with the transaction.

12. The method of claim 10, further comprising receiving a security code from the transaction device prior to sending the customer payment information for carrying out the transaction with the storefront associated with the second or with the third domain.

13. The method of claim 1, further comprising storing an associated authorization token, wherein a presentation of the authorization token from the transaction device to the payment resource allows access to the customer payment information,
sending the authorization token to the commerce management engine and to the transaction device;
receiving a checkout request and the authorization token from the transaction device;
creating an account session;
receiving updated customer payment information from the transaction device; and
storing the updated customer payment information.

14. The method of claim 1, wherein the customer account information includes a customer identifier that is at least one of a customer name, an email address, and a telephone number.

15. The method of claim 1, wherein the customer payment information includes a payment source and a billing address.

16. The method of claim 1, wherein the authorization token is in the form of at least one of a JSON token and a payment resource cookie.

17. A system comprising:
a payment resource associated with a first domain and in communication with a commerce management engine for a storefront associated with a second domain, wherein the payment resource is configured to:
receive, from the commerce management engine for a storefront associated with a second domain, customer account information for a customer of the storefront, wherein the customer account information includes customer payment information, and a request to create a customer account for the customer for future use of the customer account information;
create the customer account at the payment resource for storage of the customer account information; and
store the customer account information, wherein the payment resource is configured to provide the customer account information to a transaction device for completing transactions with at least one storefront associated with a third domain.

18. The system of claim 17, wherein the payment resource stores an authorization token, and wherein a presentation of the authorization token to the payment resource allows for access to the customer payment information.

19. The system of claim 18, wherein the authorization token is made available to the commerce management facility and to the transaction device.

20. The system of claim 17, wherein one or more of a transaction authorization, a customer name, a customer ID, and a shipping address are received via the a checkout page of a storefront from the transaction device.

21. A method for a payment resource associated with a first domain, the method comprising:
receiving, from a commerce management engine for a storefront associated with a second domain, customer account information for a customer of the storefront, wherein the customer account information includes customer payment information, and a request to create a customer account for the customer for future use of the customer account information,
wherein the request to create a customer account is received at the payment resource in response to a customer agreement to future use of the customer payment information received at the commerce management engine from a transaction device of the customer together with a transaction authorization from the transaction device for a transaction with the storefront associated with the second domain,
creating the customer account at the payment resource for storage of the customer account information;
storing the customer account information and an associated authorization token;
sending the authorization token to the transaction device; and
receiving the authorization token from the transaction device and allowing access to the customer payment information for carrying out a transaction via the transaction device with a storefront associated with a third domain.
